(19) United States
(12) Patent Application Publication
(10) Pub. No.: US 2018/0259247 A1
(43) Pub. Date: Sep. 13, 2018

(54) OPERATING A CAMERA OF A HOUSEHOLD APPLIANCE

(71) Applicant: BSH HAUSGERAETE GMBH, MUENCHEN (DE)

(72) Inventors: HANS PETER WERNER, GIENGEN (DE); GERHARD WETZL, SONTHEIM (DE)

(21) Appl. No.: 15/743,501

(22) PCT Filed: Jun. 23, 2016
(86) PCT No.: PCT/EP2016/064489

§ 371 Date: Jan. 10, 2018

(30) Foreign Application Priority Data
Jul. 22, 2015 (DE) 10 2015 213 780.5

(51) Int. Cl. F25D 29/00; H04N 5/225; F25D 23/02

(52) U.S. Cl. CPC F25D 29/005; H04N 5/2253; F25D 2700/02; F25D 23/028; F25D 2323/02; H04N 5/2252

(57) ABSTRACT

A method for operating a camera of a household appliance, in particular a refrigerator, includes calibrating the camera when a door of the household appliance is opened, outputting a trigger signal for triggering the camera at a predetermined angular position of the door and using the camera to capture at least one image without color matching in response to the trigger signal. A household appliance includes at least one camera for capturing at least one image from at least one part of an inner chamber of the household appliance and the household appliance is configured to operate at least one camera according to the method.

The invention relates to a method for operating a camera of a household appliance, wherein the camera is calibrated when a door of the household appliance opens and a trigger signal for triggering the camera is output when a predetermined angular position of the door is reached. The invention also relates to a household appliance with at least one camera for capturing an image of at least one part of an interior chamber of the household appliance. The invention can be applied advantageously to refrigerators in particular.

US 2014/0293060 A1 discloses a refrigerator. The refrigerator can have a body with a storage chamber, a first door being fastened in a rotatable manner to a first side of the body to open and close a first part of the storage chamber and a second door being fastened in a rotatable manner to a second side of the body to open and close a second part of the storage chamber. A first camera can be arranged on the first door to capture an image of an interior of the first storage chamber as the first door rotates. A second camera can be arranged on the second door to capture an image of an interior of the first storage chamber as the second door rotates. A controller can combine a number of images captured by the first camera and second camera to obtain a single corrected image of a region of the first storage chamber, which extends from the first door to the second door. This has the disadvantage that the capturing of the images is highly complex.

When the doors are closed, the cameras are in a standby mode, from which they are awoken as the respective door opens. When they are awoken, the cameras run through a first “basic calibration” which comprises for example an elimination of charges from sensor cells of the image sensor of the camera (reset), a brightness adjustment, etc. The cameras then wait for a trigger signal, which is generated when a respective angle sensor detects a defined angular position of the door(s) during opening or closing. When the trigger signal comes, a second “additional calibration” is first performed, which comprises a white balance and a focal length adjustment. A number of images are then captured, these being processed according to the calibration data. The image providing the best result is then selected from the multiple images for object recognition in the storage chamber, etc.

It is the object of the present invention to overcome at least some of the disadvantages of the prior art and in particular to make it easier to capture images of an interior chamber of a household appliance.

Said object is achieved according to the features of the independent claims. Preferred embodiments will emerge in particular from the dependent claims.

The object is achieved by a method for operating a camera of a household appliance, wherein the camera is calibrated when a door of the household appliance opens, a trigger signal for triggering the camera is output when a predetermined angular position of the door is reached (in other words reached or exceeded) and the camera captures at least one image without color matching in response to the trigger signal.

Because the camera does not have to perform color matching on receipt of the trigger signal, the time between receipt of the trigger signal and the start of image capturing is shortened. This significantly improves knowledge of the position of the door at the start of image capturing. Also fewer images have to be captured to generate a successful image (in other words an image which is suitable for further processing, for example for object recognition). This allows images of an interior chamber of a household appliance to be captured particularly easily and economically.

The outputting of the trigger signal can also be a function of whether the angular position of the door is reached or exceeded as the door is opened or closed.

In one development the camera is a digital camera. The camera can capture individual images and/or image sequences. An image sensor of the camera can be a CCD sensor or a CMOS sensor. The image sensor can have what is known as an electronic shutter, which can be operated in global shutter mode or rolling shutter mode.

The image sensor can also be referred to as an imager and can have further semiconductor structures in addition to the sensor elements or sensor cells typically arranged in the manner of a matrix, for example an oscillator, a bias generator, an A/D converter, a memory unit, a sequence controller, a logic unit, etc.

In addition to the image sensor the camera can have an electronic unit for processing image data generated by the image sensor and/or for activating the image sensor. The electronic unit can be set up for example to set defined modes and/or other settings of the image sensor. The electronic unit can have a digital signal processor (DSP), an ASIC, an FPGA, etc.

The camera can also have an interface (e.g. a USB interface) connected in particular to the electronic unit, in order to connect the camera for example to a control facility of the household appliance. The camera can output images by way of the interface, for example in JPEG, PNG, GIF, TIFF or BMP format.

From the perspective of the camera with image sensor and electronic unit the method can for example comprise the camera first receiving a signal to boot up the camera after the door has opened. The image sensor is then booted up independently or in conjunction with the electronic unit or is initialized. The electronic unit can also be booted up or initialized, the initialization of electronic unit and image sensor being coordinated in such a manner that routines allowing the operation of the image sensor according to the method are loaded first, followed by routines, in particular of the electronic unit, which are less time-critical and do not prevent image capturing, for example image processing or image transfer routines. On receipt or arrival of the trigger signal at the electronic unit, in some instances before its less time-critical routines have been loaded, the electronic unit forwards the trigger signal to the capture-ready image sensor, whereupon the image sensor captures an image and supplies it to the electronic unit. Once initialization of the electronic unit has been completed, said electronic unit can process the image further.

In one development the camera is fitted with a mechanical shutter, in particular when the image sensor is a rolling shutter image sensor. This allows sharp images of moving objects to be captured easily and economically. In particular the shutter can only be opened for a time period, during which all the sensor elements or sensor cells are simultaneously sensitive or switched to image capturing mode. This is particularly advantageous in conjunction with rolling shutter image sensors, the sensor elements of which can be switched to simultaneously sensitive (known as global start mode). A charge transfer from the sensor elements and a subsequent reading out of data can be performed when the shutter is closed again, even if this happens with a row by row time offset, as is the case with rolling shutter mode. The rolling shutter image sensor is preferably a low-cost CMOS sensor.

The camera can also have an optical system connected upstream of the image sensor, for example a CRA (chief ray angle) optical system, which uses for example microlenses to avoid a fish-eye effect.

The performance of the calibration when the door of the household appliance opens comprises in particular a performance of the calibration immediately after an opening of the door has been determined, for example by way of a door opening switch.

In one development a light of a storage chamber that can be closed by the door is switched on when the door opens.

The calibration is performed automatically by the camera and can comprise setting the brightness, eliminating the sensor element charges (reset), setting an offset, etc.

In one development the calibration of the camera is concluded when the angular position of the door is reached or exceeded, assuming normal times for opening and closing the door (e.g. of at least one second). This reduces the delay between receipt of the trigger signal at the camera and image capturing particularly significantly.

In one embodiment color matching is performed with or in the context of the calibration of at least one camera. This has the advantage that the time between the opening of the door and reaching the predetermined angular position of the door is used to perform color matching and it is not performed by the camera only after receipt of the trigger signal as before. This is advantageous particularly in the case of fast-moving doors.

Color matching serves to sensitize the camera to the color temperature of the light at the capture point. In one development color matching is a white balance, which can be used to set the camera to produce the best possible reproduction of a white value at the capture point.

Color matching can be performed in such a manner for example that an image (calibration image) used for calibration purposes is captured by means of the image sensor and color matching algorithms are then applied to the calibration image. The image sensor is calibrated using the result of this color matching. Color matching can be performed in the camera, in particular by the electronic unit connected to the image sensor. The calibration image is advantageously not output by the camera.

In a further embodiment at least one camera is operated without color matching. This can mean that color matching is not performed either with the calibration of said camera (after the door opens) or in response to the trigger signal. This ensures particularly reliably that the camera can capture an image with little delay in response to the trigger signal, even with very fast-moving doors. This embodiment utilizes the fact that a storage chamber in a body of the household appliance is lit by an integrated lighting facility when the door opens and therefore the lighting conditions—in particular a color temperature—are known at least approximately. It also utilizes the fact that the lighting conditions in the storage compartment do not generally change significantly due to incident light from outside and the number and type of objects stored. It is thus possible to dispense with color matching or color correction completely or color correction—in particular adjustment of a color temperature—can be implemented outside the camera by the subsequent processing of captured images with previously known parameters.

In a further embodiment the household appliance has a first camera for capturing an image of a storage chamber and a second camera for capturing an image of an inner face of the door and color correction—in particular adjustment of a color temperature—is performed on an image captured by the second camera by means of an image captured by the first camera. This embodiment can also be performed without camera color matching. Instead here the image of the storage chamber is used as a color reference for the second image. It is based on the fact that the color temperature of the image of the storage chamber is known but the lighting conditions at an inner face of an opened door can fluctuate significantly due the significant incidence of light from outside and a lack of inherent illumination. It can also utilize the fact that a color of a wall (e.g. white) of the storage compartment and the inner face of the door is the same so color correction can be performed particularly easily by matching points on the wall.

In yet another embodiment the color correction is performed outside the household appliance. This means that no processing capacity has to be reserved in the household appliance. The household appliance can be connected to an external data processing facility for the purpose, for example an external server. The captured images can be stored on the external server or in a decentralized memory unit, for example in what is known as the cloud.

Alternatively the color correction can be performed by the household appliance, for example by means of a data processing facility, in particular by means of an image processing facility.

In a further embodiment the camera has a fixed focal point or focal length. This has the advantage that the camera does not have to perform an automatic focal length adjustment (autofocus) on receipt of the trigger signal. This shortens a time period between receipt of the trigger signal and image capturing still further. It also means that particularly simple and low-cost cameras can be used. This is based on the fact that when there is no need for color matching and focal length setting the camera can capture images immediately or practically without delay on receipt of the trigger signal. The position of the camera is therefore known with a particularly high level of accuracy during image capturing, practically regardless of an angular speed of the door. Therefore a camera, the fixed focal length of which is matched to the predetermined angular position of the door for triggering the trigger signal can be used to capture sharp images.

In another embodiment the camera captures just one image in response to the trigger signal. This facilitates image processing and/or image analysis. This embodiment is possible, as one image with a sufficiently high level of sharpness can be captured in the camera by dispensing with color matching and in particular also with focal length setting.

In another embodiment the camera is switched off when the door closes. A switched off camera refers in particular to a camera without power. This saves electricity and extends the service life of the camera. This embodiment generally also means that the camera is switched off before the door opens (and is not simply in standby mode). When the door opens therefore the camera is switched on and booted up as a result. The booting up of the camera can comprise for example starting up, a memory unit test and at least one initialization routine. The switching off of the camera when the door closes can mean that the closing of the door is a necessary but not sufficient condition for switching off. Thus the camera can only be switched off when the door has been closed and an image transfer from the camera has been concluded.

The object is also achieved by a household appliance with at least one camera for capturing at least one part of an interior chamber of the household appliance, the household appliance being set up to operate at least one camera according to the method as described above.

In one development the household appliance is a refrigeration appliance, in particular a refrigerator and/or chest freezer or freezer cabinet. The household appliance can have one door or a number of doors. The door can close at least one storage chamber present in a body of the household appliance. The door can be configured on the inside to hold at least one object and to this end can have one or a number of storage compartments (e.g. a bottle holder, a butter compartment, an egg tray, etc.). The presence of a camera in the refrigerator can also be referred to as “camera in fridge” CiF.

A refrigerator in particular can have at least one camera for capturing a least one storage compartment present in a body and at least one camera for capturing an inner face of at least one respective door.

In particular when the household appliance has a number of cameras, said cameras can be connected to a common control facility. The control facility can be connected to an opening sensor, which can detect an opening and closing of the door, and to a sensor (angle sensor), which can detect a presence of the door in a defined angular position. The control facility can activate the cameras connected to it in groups or individually based on the opening sensor and/or the angle sensor. For example the control facility can use the opening sensor to detect an opening or closing of a door and then switch on the cameras (for example by activating a voltage supply or by emitting a switch-on signal) or switch them off. The control facility can also detect the reaching of a predetermined angular position of the door, in particular when the door is closing, based on the angle sensor and output corresponding trigger signals to the cameras to capture images. The same can also apply to just one camera.

The household appliance can have at least one wireless or wired data interface, for example an Ethernet interface, a Bluetooth interface, etc. The household appliance can be connected to an external image processing facility for example by way of the data interface. The household appliance can for example transfer images as well as associated information and receive images as well as associated information by way of the data interface.

The properties, features and advantages of the present invention as described above and the manner in which they are achieved will become clearer and more readily comprehensible in conjunction with the schematic description of an exemplary embodiment that follows, which is described in more detail in conjunction with the drawings.

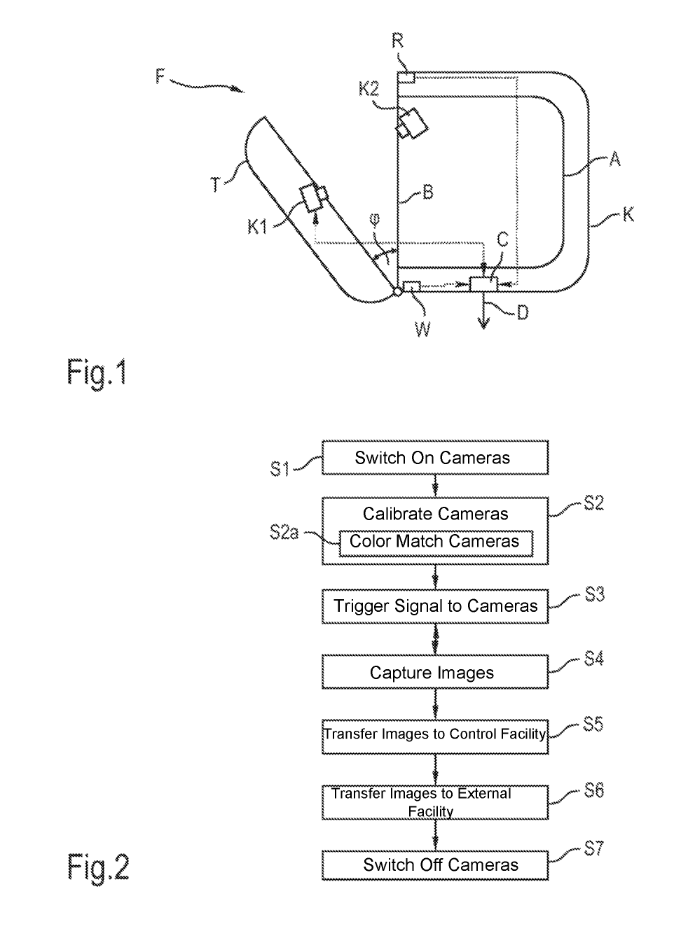

FIG. 1 shows a sectional view from above of a household refrigeration appliance in the form of a refrigerator; and

FIG. 2 shows a flow diagram for performing a method for operating a camera of the household appliance.

FIG. 1 shows a sectional view from above of a household refrigeration appliance in the form of a refrigerator F with a useful chamber or storage chamber A, the loading opening B of which is at the front and can be closed by means of a pivotable door T. A first camera K1 is arranged in the door T. A second camera K2 is also arranged on the body F, directed toward the inner face of the door T. The two cameras K1 and K2 both have a fixed focal length.

The refrigerator F also has a door opening sensor R and an angle sensor W, both connected to a control facility C. The cameras K1 and K2 are also connected to the control facility C.

The control facility C can determine an opening and closing or an opened and closed state of the door T by means of the door opening sensor R. The control facility C can detect use the angle sensor W to detect when the door T has reached or exceeded a predetermined (“trigger”) angular position φ during a closing movement for example.

The control facility C is also set up to switch on the two cameras K1 and K2, which until then have been switched off, when an opening of the door T is detected (for example by outputting a corresponding signal), which is also shown as a step S1 in FIG. 2.

The cameras K1 and K2 then perform a (“full”) calibration (step S2 in FIG. 2) which in one embodiment can comprise color matching (step S2a in FIG. 2).

Color matching can be performed by just one camera, for example the second camera K2, or both cameras K1 and K2.

If the control facility C then detects by means of the angle sensor W that the door T has reached the trigger angular position φ during its closing movement for example, it outputs a trigger signal to the cameras K1 and K2 (step S3 in FIG. 2). The angle sensor W can be for example a magnetic sensor such as a Hall sensor, a switch, etc.

On receipt of the respective trigger signal the cameras K1 and K2 are triggered and each capture just one image (step S4 in FIG. 2).

The focal length of the two cameras K1 and K2 is set such that they capture sharp images of the storage chamber A or the door inner face when capturing images. As neither color matching nor focal length adjustment is performed with the trigger signal, the images are captured practically without delay. This in turn means that the position of the cameras K1 and K2 in relation to the storage chamber A or the door inner face is known with a high level of accuracy at the trigger time point practically regardless of an angular speed of the door T and can be equated for example to the position of the door T in the trigger angular position φ.

The captured images are transferred by the cameras K1 and K2 to the control facility C (step S5 in FIG. 2), for example by way of a USB interface. The control facility C can further process the images itself, for example performing color correction, object recognition, etc.

Alternatively or additionally the control facility C can transfer the images wirelessly or in a wired manner to an external image processing facility D for image processing, said image processing facility D being located in a cloud or on a dedicated server (step S6 in FIG. 2). Information acquired from image processing (e.g. a color-corrected image, objects recognized as present or absent and/or associated information, such as a passed expiry date, next purchasing opportunity, etc.) can be sent back to the household appliance F and can be displayed there for example on a screen (not shown) present on the outer face of the door T.

The cameras K1 and K2 can be switched off when the images they have captured have been transferred to the control facility C and/or the door T has been closed again (step S7 in FIG. 2).

The present invention is of course not restricted to the illustrated exemplary embodiment.

Generally “one” can refer to a single one or a number, in particular in the sense of “at least one” or “one or more”, etc., unless this is specifically excluded, for example by the expression “just one”, etc.

Also a number can comprise just the stated number as well as a standard tolerance range, unless this is specifically excluded.

### LIST OF REFERENCE CHARACTERS

K1 Camera
K2 Camera
A Storage chamber
B Loading opening
C Control facility
K Refrigerator
R Door opening sensor
S1-S6 Method steps
T Door
W Angle sensor
φ Trigger angular position

1-9. (canceled)

10. A method for operating a camera of a household appliance, the method comprising the following steps:
calibrating the camera when a door of the household appliance opens;
outputting a trigger signal for triggering the camera when a predetermined angular position of the door is reached; and
using the camera to capture at least one image without color matching in response to the trigger signal.

11. The method according to claim 10, which further comprises performing color matching with the calibration of the camera.

12. The method according to claim 10, which further comprises operating the camera without color matching.

13. The method according to claim 12, which further comprises:
providing the camera as one of a first camera for capturing an image of a storage chamber and a second camera for capturing an image of an inner face of the door of the household appliance; and
performing color correction on an image captured by the second camera by using an image captured by the first camera.

14. The method according to claim 13, which further comprises performing the color correction step outside the household appliance.

15. The method according to claim 10, which further comprises providing the camera with a fixed focal point.

16. The method according to claim 10, which further comprises using the camera to capture just one image in response to the trigger signal.

17. The method according to claim 10, which further comprises switching off the camera when the door closes.

18. A household appliance, comprising:
an interior chamber of the household appliance;
a door closing said interior chamber;
at least one camera for capturing at least one image from at least one part of said interior chamber; and
a control facility programmed for:
calibrating said at least one camera when said door opens;
outputting a trigger signal for triggering said at least one camera when a predetermined angular position of said door is reached; and
using said at least one camera to capture at least one image without color matching in response to the trigger signal.
